(19) United States
(12) Patent Application Publication
(10) Pub. No.: US 2005/0122250 A1
(43) Pub. Date: Jun. 9, 2005

(54) Radar systems

(75) Inventor: Martin Stuart Taylor, Chelmsford (GB)

Correspondence Address: CONNOLLY BOVE LODGE & HUTZ LLP, SUITE 800, 1990 M STREET NW, WASHINGTON, DC, 20036-3425, US

(73) Assignee: SMITHS GROUP PLC, London (GB)

(21) Appl. No.: 10/981,548

(22) Filed: Nov. 5, 2004

(30) Foreign Application Priority Data
Dec. 9, 2003 (GB) 0328457.7

(51) Int. Cl. G01S 13/93

(52) U.S. Cl. 342/41

(57) ABSTRACT

A radar system for a marine vessel has an antenna unit mounted at the top of a mast and a radar display at a remote location. The antenna unit comprises an outer housing containing: an antenna, a motor and gearbox to rotate the antenna to scan in azimuth, a transceiver connected to receive radar signals from the antenna and an analogue-to-digital converter. Digital signals from the converter are supplied down the mast via cabling, which extends to a processor adjacent the display. The processor converts the digital signals into a form for display.

### BACKGROUND OF THE INVENTION

This invention relates to radar systems.

International regulations now require vessels greater than 300 gross tonnage to be fitted with marine navigation radar. Often much smaller vessels also carry navigation radar.

Marine radar systems comprise an antenna mounted at the top of a mast with a motor and gearbox to rotate the antenna about a vertical axis, to scan in azimuth. A transceiver provides the microwave signal propagated by the antenna and also is supplied with signals received by the antenna. The transceiver converts the received signals into analogue electrical signals, which are then supplied to a processor for digitisation and display.

In a so-called “upmast” system, the transceiver is mounted directly under the antenna at the top of the mast. The transceiver supplies analogue radar information signals via a cable down the mast to a remote processor unit, which converts the signals to a digital form for display. Separate lines in the cabling are used to control the motor, to supply video, sync and heading information.

In a so-called “downmast” system, the transceiver is mounted separately from the antenna, usually in an electronics room or the like where it is readily accessible. The transceiver is connected to the antenna by a flexible or solid waveguide, or by a low-loss coaxial cable. Again, the analogue output of the transceiver is converted to digital form for display purposes.

Both these systems have disadvantages in that they require special forms of cabling and connections to ensure low loss and immunity to interference.

### BRIEF SUMMARY OF THE INVENTION

It is an object of the present invention to provide an alternative radar system.

According to one aspect of the present invention there is provided a marine radar system including an antenna, means for rotating the antenna to scan in azimuth, transceiver means mounted adjacent the antenna for receiving radar signals from the antenna, analogue-to-digital converter means mounted adjacent the transceiver means, cabling extending from the analogue-to-digital converter means to processing means mounted at a remote location by which the radar signals are converted to a form for display.

The means for rotating, the transceiver means and the analogue-to-digital converter means are preferably contained within a common housing. The antenna and housing are preferably arranged for mounting towards the top of a mast. The means for rotating the antenna preferably includes an electric motor and a gearbox.

According to another aspect of the present invention there is provided a radar system including an antenna unit, processor means remote from the antenna unit, cabling extending from the antenna unit to the processing means and display means connected to receive an output from the processing means, the antenna unit including an antenna, transceiver means for receiving radar signals from the antenna, means for scanning the antenna in azimuth and means for converting signals received by the antenna into digital form to provide a digital output to the cabling.

The antenna unit may have an outer housing enclosing the scanning means, transceiver means and converting means. The scanning means preferably includes an electric motor and a gearbox.

According to a third aspect of the present invention there is provided a marine vessel including a radar antenna mounted on an elevated, exposed structure of the vessel, motor means mounted with the antenna for rotating the antenna in azimuth, transceiver means coupled with and adjacent the antenna, the vessel including an analogue-to-digital converter mounted adjacent the antenna and connected with the transceiver to provide a digital output, cabling connected electrically with the analogue-to-digital converter and extending to a remote location, processing means located at the remote location and adapted to receive digital signals from the cabling and display means located at the remote location and connected to receive an output from the processing means.

Two conventional marine vessel radar systems and a novel system according to the present invention will now be described, by way of example, with reference to the accompanying drawings.

### BRIEF DESCRIPTION OF THE DRAWINGS

FIG. 1 is a schematic diagram showing a conventional upmast transceiver system;

FIG. 2 is a schematic diagram showing a conventional downmast transceiver system; and

FIG. 3 is a schematic diagram of the system of the present invention.

### DETAILED DESCRIPTION OF A CONVENTIONAL UPMAST SYSTEMS

With reference first to FIG. 1 there is shown a marine vessel 1 with a mast 2 and an enclosed structure such as a bridge 3. An antenna unit 4 is secured at the top of the mast 2, the unit comprising an antenna 5 coupled with a gearbox 6, which is driven by an electrical motor 7. The unit 4 also includes a transceiver 8 coupled with the antenna 5 for supply of microwave energy to and from the antenna. The transceiver 8, therefore, is also mounted towards the top of the mast 2. The transceiver 8 produces an analogue electrical output and is connected to one end of cabling 9, which includes dedicated lines for control of the motor and separate lines for video, sync and heading line information. The cabling 9 extends down the mast 2 and through the vessel 1 to the structure 3 where it connects with a processing unit 10. The processing unit 10 provides an output to a display 11 or other utilisation means such as a store, voyage data recorder or the like. Because the analogue signal has to be transmitted a relatively long distance, the cabling must have a low resistance, making it relatively thick and inflexible. Interconnections with the cabling also present problems because of the need to minimize losses. Suitable cabling is expensive, is difficult to install and requires special connectors.

### DETAILED DESCRIPTION OF A CONVENTIONAL DOWNMAST SYSTEMS

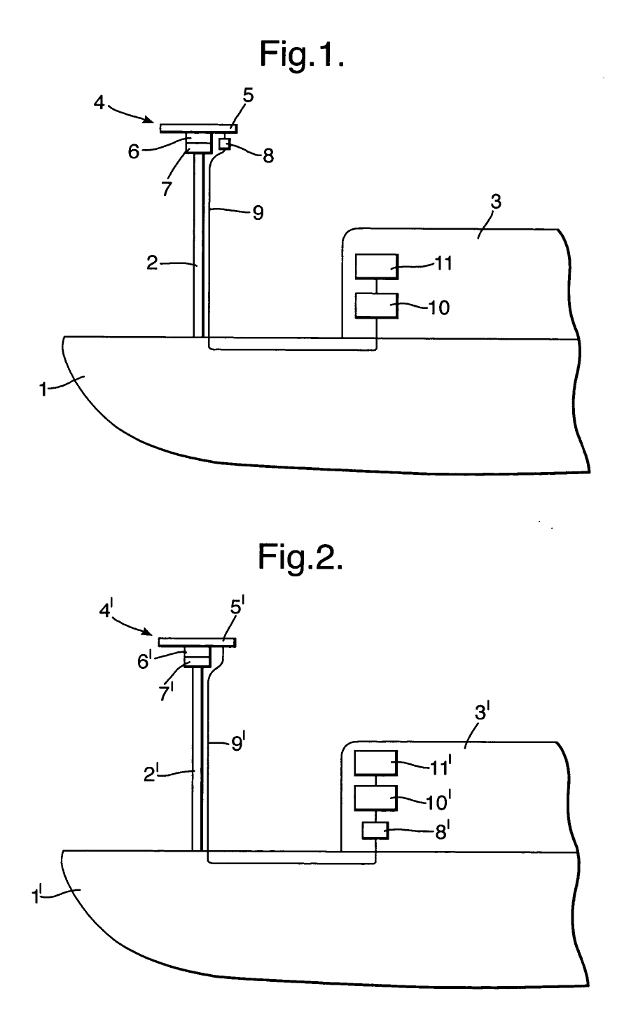

Many of the features of the system shown in the downmast system of FIG. 2 are common to the system of FIG. 1 so have been given the same reference number with the addition of a prime ′. In the system of FIG. 2, the unit 4′ including the antenna 5′, gearbox 6′ and motor 7′ is mounted at the top of the mast 2′, as in the upmast system of FIG. 1. The system of FIG. 2 differs in that the transceiver 8′ is not included in the antenna unit 4′ and is not mounted up the mast 2′ but instead is mounted in the structure 3′. The transceiver 8′ is interconnected with the antenna 5′ by cabling 9′ in the form of a low-loss coaxial cable, or by means of a flexible or solid waveguide with additional control and signal cables. The need to provide such a length of coaxial cable or waveguide is a disadvantage but it does mean that the electronics can be located where access for maintenance is easier.

### DETAILED DESCRIPTION OF THE PREFERRED EMBODIMENT

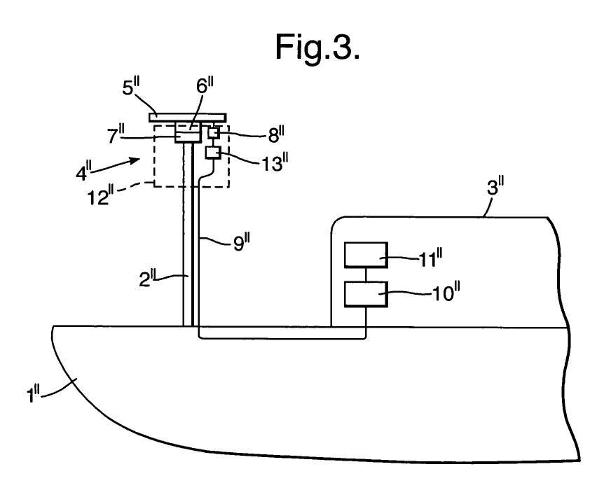

With reference now to FIG. 3, the system according to the present invention will now be described and, because many of the features are common with those in the system of FIG. 1 they have been given the same reference numeral with the addition of two primes ″. The system has an antenna unit 4″ with an outer housing 12″ mounted at the top of the mast 2″ or some other elevated, exposed structure of the vessel 1″. The unit 4″ includes an antenna 5″ and the housing 12″ contains a gearbox 6″ and an electrical motor 7″ coupled with the antenna and by which the antenna is rotated and scanned in azimuth. The housing 12″ also contains the transceiver 8″, which is mounted on the antenna 5″ to rotate with it. The transceiver 8″ produces an analogue electrical output and is electrically connected with an analogue-to-digital converter 13″ also contained within the housing 12″. The converter 13″ provides a digitally-encoded output in some suitable protocol such as ethernet. The output of the converter 13″ connects with one end of a Cat-5 network cable 9″ or some other similar cabling. The cable 9″ extends from the housing down the mast 2″ to a processor unit 10″ within the structure 3″. The processor unit 10″ provides an output to the display 11″ or other utilisation means.

The signal from the antenna unit 4″ is in digital form so it can be transmitted along a lightweight, flexible cable 9″ relatively large distances with high reliability. It also enables the output of the antenna to connect to a local area network or other databus along with digital information from other sources.

The antenna unit need not have an outer housing. Instead, the transceiver and analogue-to-digital converter could be exposed and mounted adjacent one another, adjacent the antenna. Instead of an electrical output, the analogue-to-digital converter could provide an optical output and the cable could include a fibre-optic cable.

1. A marine radar system comprising: an antenna; a motor for rotating the antenna to scan in azimuth; a transceiver mounted adjacent the antenna for receiving radar signals from the antenna; an analogue-to-digital converter mounted adjacent the transceiver; a processor mounted at a remote location by which the radar signals are converted to a form for display; and cabling extending from the analogue-to-digital converter to the processor

2. A marine radar system according to claim 1, wherein said motor, said transceiver and said analogue-to-digital converter are contained within a common housing.

3. A marine radar system according to claim 2, wherein said antenna and said housing are arranged for mounting towards the top of a mast.

4. A radar system comprising: an antenna unit, a processor remote from the antenna unit, cabling extending from the antenna unit to the processor and a display connected to receive an output from the processor, wherein said antenna unit includes an antenna, a transceiver for receiving radar signals from said antenna, apparatus for scanning the antenna in azimuth and a converter for converting signals received by said antenna into digital form to provide a digital output to said cabling.

5. A radar system according to claim 4, wherein said antenna unit includes an outer housing enclosing said scanning apparatus, said transceiver and said converter.

6 A radar system according to claim 4, wherein said scanning apparatus includes an electric motor and a gearbox.

7. A marine vessel having an elevated, exposed structure, such as a mast, and a location remote from the exposed structure, wherein the vessel includes mounted on said structure: a radar antenna; a motor mounted with said antenna for rotating the antenna in azimuth; a transceiver coupled with and adjacent said antenna; and an analogue-to-digital converter mounted adjacent said antenna and connected with said transceiver to provide a digital output, wherein said remote location includes a processor and a display connected with said processor, and wherein said vessel includes cabling extending between said analogue-to-digital converter at said exposed structure to said processor at said remote location so as to supply digital signals from said converter to said processor.
